(19) United States
(12) Patent Application Publication
(10) Pub. No.: US 2018/0374138 A1
(43) Pub. Date: Dec. 27, 2018

(54) LEVERAGING DELAYED AND PARTIAL REWARD IN DEEP REINFORCEMENT LEARNING ARTIFICIAL INTELLIGENCE SYSTEMS TO PROVIDE PURCHASE RECOMMENDATIONS

(71) Applicant: Vufind Inc., Sunnyvale, CA (US)

(72) Inventor: Moataz A. Rashad Mohamed, Berkeley, CA (US)

(73) Assignee: Vufind Inc., Sunnyvale, CA (US)

(21) Appl. No.: 15/632,154

(22) Filed: Jun. 23, 2017

(51) Int. Cl. G06Q 30/06; G06N 99/00; G06N 3/08; G06N 3/04

(52) U.S. Cl. CPC G06Q 30/0631; G06N 3/0445; G06N 3/08; G06N 99/005

(57) ABSTRACT

Systems, methods, and computer-readable media for delivering recommendations are provided to personalize user experience, optimize online advertising, and maximize revenue for online merchants. An example system can include a computer configured to: receive historic user online actions data and one or more purchase confirmations of a user, train a deep reinforcement learning system based on the received data, receive a current observation characterizing interaction of the user with at least one of the recommendations in an online environment, determine a reward for the deep reinforcement learning system based on the current observation, where the reward depends on a time parameter associated with an intended action of the user, select an action to be performed by an agent based on the reward, and cause the agent to provide or display a new recommendation to the user or another comparable user based on the selected action.

### BACKGROUND

### Technical Field

This disclosure generally relates to electronic commerce methods and systems for providing targeted online advertising and purchase recommendations to users. More particularly, this disclosure relates to deep reinforcement learning systems adapted to optimize the generation and delivery of online advertising and purchase recommendations.

### Description of Related Art

Advertisers and merchants are constantly searching for more efficient ways to advertise products and services in the Internet in order to maximize conversion rate, increase engagement and maximize revenue for the merchants. One common marketing approach includes online advertising campaigns aimed to reach large groups of people. For example, advertising messages can be embedded into web pages, e-mails, and social media feeds. These approaches are costly and ineffective. Marketers, however, have been able to develop better and more personalized advertising campaigns in order improve user engagement, and conversion rate. It is currently common to track consumer shopping habits in the Internet, their online behaviors, browsing history, search history, location and other information that informs a behavioral profile of the users and to determine particular items of consumer interest. Based on the tracked information, online recommendation (advertising) systems can generate personalized purchase recommendations and cause their display on a screen of user devices. This approach is not always effective to promote relevant products and services individually to users. A problem with this type of advertising is that the online recommendation systems cannot accurately determine if a user is truly interested in a particular product or service unless the user completes a purchase immediately after a particular purchase recommendation is presented. In those instances, when the user received a purchase recommendation, reviewed it, but decided to postpone making a purchase decision (e.g., for a few days or weeks), are not trackable and hence can not be leveraged by the merchant to optimize the efficacy of the recommendations further. For example, if the user buys the recommended product several days after watching a purchase recommendation, the online recommendation system would not be able to track it and account for it to generate similar relevant purchase recommendations for said user or other users with comparable behavioral profiles.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to one aspect of the current invention, a computer-implemented method for delivering purchase recommendations is provided. An example method includes: receiving historic user online actions data and one or more purchase confirmations of a user, training a deep reinforcement learning system based on the historic user online actions data and the purchase confirmations of the user to enable the deep reinforcement learning system to provide one or more purchase recommendations to the user, receiving a current observation characterizing interaction of the user with at least one of the purchase recommendation of the deep reinforcement learning system presented in an online environment, determining a reward for the deep reinforcement learning system based on the current observation, where the reward at least partially depends on a time parameter associated with an intended action of the user, selecting an action to be performed by an agent of the deep reinforcement learning system based on the reward, and causing the agent to perform the selected action, where the selected action includes presenting or displaying a new purchase recommendation to the user or another comparable user.

According to another aspect of the current invention, a system for delivering purchase recommendations is provided. An example system comprises a processor and a memory storing processor-executable code. The processor is configured to execute the processor-executable code to: receive historic user online actions data and one or more purchase confirmations of a user, train a deep reinforcement learning system based on the historic user online actions data and the purchase confirmations of the user to enable the deep reinforcement learning system to provide one or more purchase recommendations to the user, receive a current observation characterizing interaction of the user with at least one of the purchase recommendation of the deep reinforcement learning system presented in an online environment, determine a reward for the deep reinforcement learning system based on the current observation, where the reward at least partially depends on a time parameter associated with an intended action of the user, select an action to be performed by an agent of the deep reinforcement learning system based on the reward, and cause the agent to perform the selected action, where the selected action includes presenting or displaying a new purchase recommendation to the user or another comparable user.

According to yet another aspect of the current invention, there is provided a non-transitory computer-readable medium comprising instructions stored thereon, which when executed by a computer, cause the computer to implement the above-outlined method for delivering purchase recommendations.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments of this disclosure are illustrated by way of an example and not limitation in the figures of the accompanying drawings, in which like references indicate similar elements and in which:

FIG. 1 illustrates a high-level block diagram of example system architecture suitable to implement methods for delivering purchase recommendations according to various embodiments;

FIG. 2 is a flow diagram of an example high-level operation method of the system architecture shown in FIG. 1 according to one example embodiment;

FIG. 3 shows a graph depicting example calculated reward values where a lower curve represents an undiscounted calculation model, while an upper curve represents an undiscounted calculation model;

FIG. 4 shows an example pseudo which can be used to implement a Markov Decision Process framework for implementing a method for delivering purchase recommendations;

FIG. 5 is a flow diagram of an example method for delivering purchase recommendations according to one example embodiment; and

FIG. 6 illustrates an example computer system which can be used to perform the methods for delivering purchase recommendations according to one embodiment as disclosed herein.

### DETAILED DESCRIPTION

Introductory Remarks

The following detailed description of some embodiments of the current invention includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Present teachings may be implemented using a variety of technologies, including computer software, electronic hardware, or a combination thereof, depending on the application. Electronic hardware can refer to a processing system, such as a computer, workstation or server that includes one or more processors. Examples of processors include microprocessors, microcontrollers, Central Processing Units (CPUs), digital signal processors (DSPs), field programmable gate arrays (FPGAs), programmable logic devices (PLDs), state machines, gated logic, discrete hardware circuits, and other suitable hardware configured to perform various functions described throughout this disclosure. The term “processor” is intended to include systems that have a plurality of processors that can operate in parallel, serially, or as a combination of both, irrespective of whether they are located within the same physical localized machine or distributed over a network. A network can refer to a local area network (LAN), a wide area network (WAN), and/or the Internet. One or more processors in the processing system may execute software, firmware, or middleware (collectively referred to as “software”). The term “software” shall be construed broadly to mean instructions, instruction sets, code, code segments, program code, programs, subprograms, software components, applications, software applications, mobile applications, software packages, routines, subroutines, objects, executables, threads of execution, procedures, functions, etc., whether referred to as software, firmware, middleware, microcode, hardware description language, and the like. If the embodiments of this disclosure are implemented in software, it may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage, solid state memory, or any other data storage devices, combinations of the aforementioned types of computer-readable media, or any other medium that can be used to store computer executable code in the form of instructions or data structures that can be accessed by a computer.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

The term “purchase recommendation” shall be construed to mean any message, text, image, video, banner, widget, or another physical or virtual medium for conveying information such as an advertisement or recommendation to purchase a product or service. The terms “purchase recommendation” and “recommendation” can be used interchangeably and shall mean the same.

The term “user” and “customer” can be used interchangeably and mean an individual (end-user), who receives purchase recommendations and optionally makes a purchase. The term “e-commerce” shall be construed to mean electronic commerce.

The term “reward” shall mean a signal or data representing, for example, a numeric value characterizing one or more of the following: a user action associated with a purchase recommendation or a product/service related a certain purchase recommendation, a user intention to make a purchase of a product/service related a certain purchase recommendation, a user reaction to a purchase recommendation, a state of deep reinforcement learning system, a state of an online environment, a process of transitioning of from one state to another, and the like.

The terms “environment” and “online environment” can be used interchangeably and shall be construed to mean a virtual environment that can react or be modified in response to user actions, inputs, or interactions. For example, the online environment may be a website, such as an e-commerce website or online store. A user can review, like, place a product to a virtual basket, place a product to a wish list, or purchase certain products or services on the website. In another example, the online environment can refer to a mobile application, software application, web service, or software enabling the users to order or purchase products or services.

The term “agent” shall be construed to mean a computer program, software, or robot configured to perform, cause, initialize, or facilitate performing certain actions with or in the online environment. For example, the agent can be configured to select certain purchase recommendations and present or display the selected purchase recommendations to certain users. In another example, the agent can be configured to receive an instruction or command of a deep reinforcement learning system and perform an action in the online environment (e.g., present certain purchase recommendations to selected users via a website, email, or mobile application) based on the received instruction. The agent can also perform other actions such as simulating operations of a user or aggregate data from the online environment.

The term “observation” shall be construed as a signal or data representing a user action performed within an online environment, for example, in response to a purchase recommendation.

Technology Overview

This disclosure is generally concerned with methods and systems for intelligent selection and delivery of purchase recommendations to users in an online environment using an artificial intelligence (AI) system, such as a deep reinforcing learning system, which is configured to leverage delayed and partial rewards. The technology of this disclosure is directed to overcome at least some drawbacks known in the art such as to account for delayed user feedback, intention or action associated with earlier presented purchase recommendations. The present technology enables accurately modeling delayed intent signals and integrating them into the deep reinforcement learning system such that their effect impacts agent's decisions, thus driving a higher purchase conversion rate. The present technology therefore enables not only optimizing the content and delivery of purchase recommendations, but also maximizing revenue of online merchants.

Note that the technology disclosed herein is not limited to e-commerce and delivery of purchase recommendations, rather it can be applied or integrated into various systems where delayed intent or delayed feedback can be leveraged to maximize a desired outcome. For example, the present technology can be used in managing manufacturing processes, supply chain processes, inventory management processes, shipping and delivery management processes, and so forth. This disclosure is primarily based on one example related to e-commerce, however, it shall be understood that it is merely one example implementation and those skilled in the art could apply the technology of this disclosure in other industries or technology fields.

According to various embodiments of this disclosure, a deep reinforcement learning system interacts with one or more agents and one or more online environments. Each agent can represent a software application or system configured to perform certain predetermined actions with an online environment. For example, an agent can be responsible for generating or selecting content of purchase recommendations and also delivering the purchase recommendations to selected users through one of the online environments. As explained above, the online environment can refer to any virtualized computer environment, such as a website, mobile application, or web service. The online environment can be configured to present purchase recommendations in response to agent's instructions. For example, when the online environment is a website, one or more purchase recommendations can be presented to users as web banners, images, hyperlinks, and the like. When the online environment refers to software (e.g., mobile application, software application), the purchase recommendations can be presented to the users as text or image widgets within a graphical user interface of the software. When the online environment refers to web service, the purchase recommendations can be presented to the users via emails, text messages, multimedia messages, push notifications, pop-up messages, and so forth.

The deep reinforcement learning system and the agent interact with the online environment by receiving one or more “observations.” Each observation fully or partially characterizes a user action performed in the online environment. For example, an observation can include certain characteristics of user's behavior (e.g., user feedback, browsing history, search history, user actions, etc.). In other embodiments, an observation can fully or partially characterize a user action performed in the online environment in response to at least one purchase recommendation. For example, the observation can relate to user interaction with the purchase recommendation (e.g., click, review, browse, scroll, save for later, bookmark, share, like, online purchase, etc.).

In addition, the observation can include a purchase confirmation or purchase conversion data. In other words, the observation can be associated with a confirmation that a particular user placed a particular item into a virtual basket, a confirmation that the user liked a certain product (goods) or service, a confirmation that the user shared information about a certain product or service via social media, a confirmation that the user save a certain product or service for later purchase, and the like.

In response to the observations, the deep reinforcement learning system determines or calculates rewards. Generally, a reward is a numeric value that characterizes a user action performed in the online environment and timing of the user action. Thus, each reward is a function of the observation made in the online environment and time. The reward is used by the deep reinforcement learning system to select a particular action to be performed by the agent in response to the observation.

Thus, the deep reinforcement learning system instructs the agent to perform one or more actions selected from a predetermined set of actions depending on the reward. The set of actions can be pre-programmed by a merchant, advertiser, or an operator of the deep reinforcement learning system based on needs of merchants or advertisers. For example, one action can relate to select a purchase recommendation that is relevant to a particular user based on the observation and reward, and present the selected purchase recommendation to the user via the online environment.

This process can be repeated as many times as needed. As the behavior of users can be learned from the repetitive process, the deep reinforcement learning system may use one or more neural networks or AI systems. For example, a neural network can be configured to receive and process an observation and a reward to generate an action.

Generally, neural networks are machine-learning algorithms that employ one or more layers, including an input layer, an output layer, and one or more hidden layers. At each layer (except the input layer), an input value is transformed in a non-linear manner to generate a new representation of the input value. The output of each hidden layer is used as an input to the next layer in the network, i.e., the next hidden layer or the output layer. Each layer of the network generates an output from a received input in accordance with current values of a respective set of parameters.

The deep reinforcement learning system can be based on any applicable neutral network, including, but not limited, feedforward deep neural network, convolutional neural network, a recurrent neural network, and the like. Any or all of the neural networks or AI systems of deep reinforcement learning system can be dynamically trained based on historic data (e.g., historic user online actions data, purchase confirmations, intermediate user actions data, historic multiple user session data, etc.).

System Architecture and Operation

Example embodiments are described below with reference to the drawings. The drawings are schematic illustrations of idealized example embodiments. Thus, the example embodiments discussed herein should not be construed as being limited to the particular illustrations presented herein, rather these example embodiments can include deviations and differ from the illustrations presented herein.

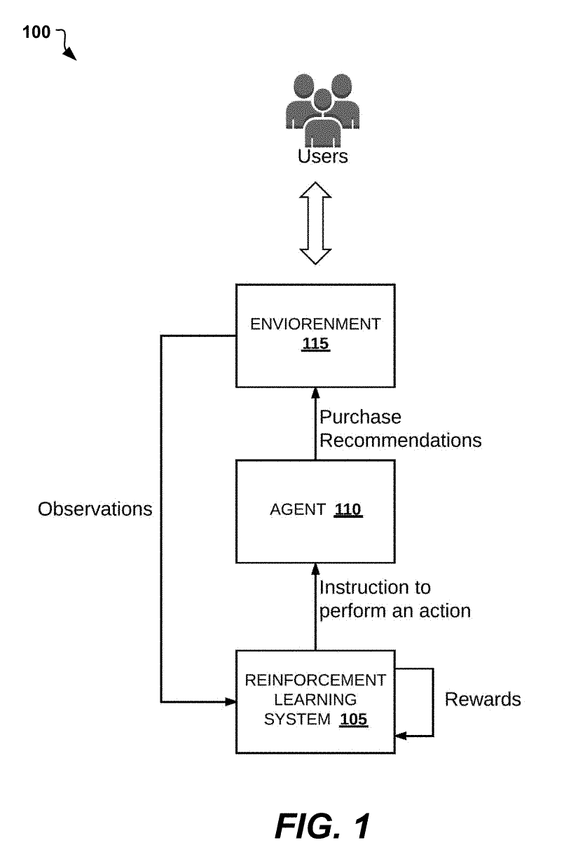

FIG. 1 shows a high-level block diagram of system architecture 100 according to one embodiment. System architecture 100 is an example of a system implemented as one or more software applications on one or more computers, workstations, or servers. Elements of system architecture 100 can be distributed and communicate via one or more communications networks, including, for example, any wired, wireless, or optical data network. As such, system architecture 100 can be implemented as a distributed computer architecture (i.e., as a “cloud” computing system).

As shown in the figure, system architecture 100 includes a deep reinforcement learning system 105, an agent 110, and an online environment 115. Deep reinforcement learning system 105 and agent 110 can run on separate computers or servers, but not necessarily. In some embodiments, deep reinforcement learning system 105 and agent 110 can be integrated into a single software product (package) and be deployed on same computers or servers.

As briefly described above, online environment 115 can be a website (e.g., online store) or a web service or a mobile application installed on a user device such as a smart phone, cellular phone, tablet computer, laptop computer, etc. The mobile applications can be suitable to make online purchases or orders of products or services.

Agent 110 is a computer program, software product, or software robot responsible for performing certain actions based on instructions, commands or other data received from deep reinforcement learning system 105. For example, agent 110 can generate, select, and deliver certain purchase recommendations (e.g., individualized purchase recommendations in the form of text, image, or multimedia) to selected users based on instructions generated by deep reinforcement learning system 105.

Online environment 115 can be configured to enable the users to interact with online environment 115. For example, certain purchase recommendations can be presented to users via online environment 115. In addition, online environment 115 may enable the users to make online purchases associated with the presented purchase recommendations. In addition, the users can interact with online environment 115 to like a product/service, share a product/service with other users, virtually save a product/service for later purchase, and so forth. In any case, online environment 115 can monitor any and all user actions and generate corresponding observations.

Deep reinforcement learning system 105 selects or determines actions to be performed by agent 110 that interacts with online environment 115 based on rewards. Particularly, deep reinforcement learning system 105 receives one or more observations characterizing a user action made in online environment 115, calculates a reward based on at least one of observations, and selects one or more actions to be performed by agent 110 based on the calculated reward. For example, observations can refer to a user feedback in response to displaying a purchase recommendation. This feedback can include three typical industry standard actions: (1) a click action; (2) a save-for-later action (also known as “save-to-wish-list” action); and (3) an immediate purchase action. The observations can also, or in an alternative, include user online behavior, a user online browsing history, a user online searching history, a user action to review or watch a purchase recommendation, share a purchase recommendation via a social media, and the like.

Once agent 110 has performed the selected action according to an instruction received from deep reinforcement learning system 105, deep reinforcement learning system 105 can again determine or calculates a next reward resulting from agent 110 performing the action in online environment 115. The next reward can include a numerical value characterizing a result of the performance of the action by agent 110 in response to a certain observation. When the above process is iteratively repeated, deep reinforcement learning system 105 is trained.

The rewards can be calculated by deep reinforcement learning system 105 to account timing between the purchase recommendation of a product/service and a user's purchase of the product/service, and optionally some intervening or intermediate events. For example, the highest reward can be assigned to immediate purchases. However, as explained above, the problem that many users interact with purchase recommendations (e.g., by clicking on them or reading reviews), but then end up delaying the actual purchase of recommended product or service for a long period. Similarly, the wish list saved by the user can be forgotten. To capture delayed intent, deep reinforcement learning system 105 uses one more additional signals or values that indicate a time-frame for a purchase intent. These signals (values) can also refer to time parameters that denote the most likely time in future the user intends to complete a particular purchase. This enables deep reinforcement learning system 105 to leverage this intelligence in making other equally intelligent recommendations to similar users browsing similar products or services in online environment 115 thereby maximizing the conversation rate and revenue of online merchants.

Thus, in various embodiments of this disclosure, these signals can characterize: (1) intend to act/purchase within 1 week; (2) intend to act/purchase within 2 weeks; and (3) intend to act/purchase within 1 month. Obviously, other time parameters can be used. Therefore, deep reinforcement learning system 105 models the delayed purchase intent as a delayed “time-decay reward.” Deep reinforcement learning system 105 can employ Markov Decision Process (MDP) to process the above-described “typical industry standard action” rewards and newly introduced time-decay rewards.

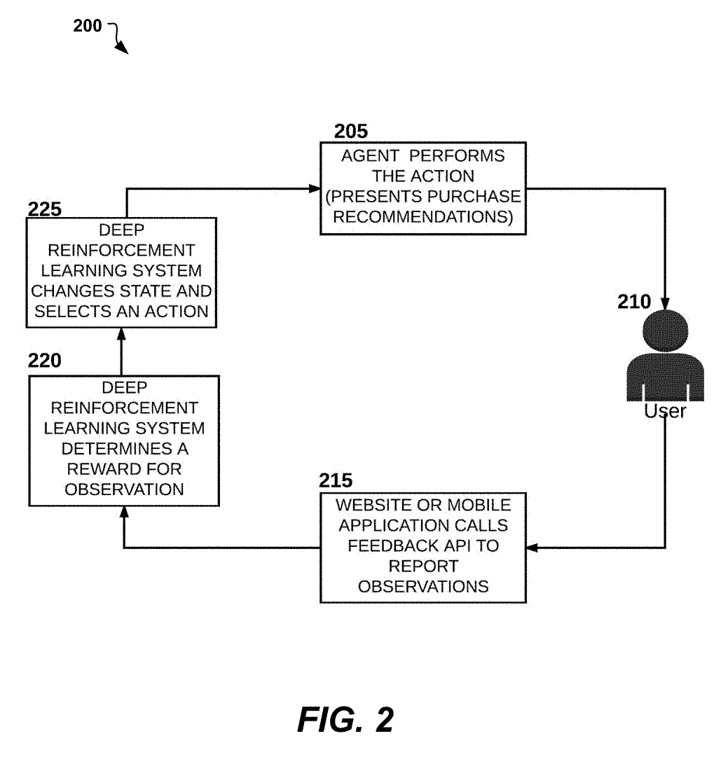

FIG. 2 is a flow diagram of an example operation method 200 of system architecture 100 shown in FIG. 1. As shown in the figure, at operation 205, agent 110 presents one or more purchase recommendations to a user via an environment such as online environment 115. For example, agent 110 causes online environment 115 to display web banners, widgets, text, images, actionable buttons, or hyperlinks on a website pertaining to a particular product or service. These initial recommendations can be generic, randomly selected, or predetermined (e.g., by the merchant). However, when deep reinforcement learning system 105 is trained based on historic user online actions data, purchase conversions (confirmations) data, historic data pertained to other similar users, and other information, deep reinforcement learning system 105 cause presenting more targeted purchase recommendations to users individually. The more deep reinforcement learning system 105 is trained, the more relevant purchase recommendations are for particular user.

Further, deep reinforcement learning system 105 is attempting to learn transitions in the environment and find an optimal policy targeted to deliver purchase recommendations. Deep reinforcement learning system 105 performs these tasks by solving sequential decision-making problems. Particularly, at operation 210, the user reacts to at least one of the purchase recommendations by clicking on one of the purchase recommendations, reviewing it, reading it, sharing it with other users via social media, placing into a virtual basket, saving it in a wish list, or by performing other actions. Accordingly, at operation 215, an observation characterizing one or more of the user actions is collected or identified by deep reinforcement learning system 105. For example, the observation can be obtained at deep reinforcement learning system 105 upon calling certain Application Programming Interface (API) codes by the website or mobile application where the purchase recommendation were presented.

Based on the observation, deep reinforcement learning system 105 determines a reward at operation 220. Each reward is calculated to characterize one user action, such as a click, save-for-later action, and immediate purchase action, and a time frame for purchase intent. In some implementations, the reward is calculated based upon two or more observations. For example, the reward can be selected or calculated based on observations of user actions (e.g., a user making a purchase of a product that is associated with earlier presented purchase recommendation) and intermediate user actions. The intermediate user actions can refer to user actions that characterize a user delayed intent to make a purchase of the product that is associated with earlier presented purchase recommendation. For example, the intermediate user actions can include or be associated with sharing purchase recommendations via social media, saving product information for later purchase, reviewing or watching a purchase recommendations of a predetermined number of times, etc. Thus, each reward essentially combines a delayed reward value and a partial reward value, where the delayed reward value is calculated based on a main user action such as an immediate purchase action, while the partial reward value is calculated based on one or more of the intermediate user actions. The partial reward value can be modeled as a time-decaying function to reduce the impact of the user delayed intent to purchase the product on the reward value.

At operation 225, deep reinforcement learning system 105 selects an action to perform by agent 110 based on the reward, sends the instruction to agent 110 for execution of the selected action, and transitions to a new state after agent 110 performs the action. The actions performed by agent 110 include presenting or delivering purchase recommendations to the selected user. The purchase recommendations can be tailored, selected, or otherwise generated based on the reward. Respectively, method 200 returns to operation 205 with the delivery of purchase recommendation to the user. Further, operations 205 through 225 can be repeated.

The operation of deep reinforcement learning system 105 is further explained relying on a mathematical model. Let's denote a reward of delayed purchase within a period of length p time-steps (for example, p days) to be R_p and using a discount factor gamma G. Accordingly, the reward R_p at each time step i will be modeled as a sum of rewards earned at that state due to a user action at that state, in addition to a discounted incremental reward R_i, where

R_i=Ĝi*R_p*(P−i)/P

Gamma G is typically between 0.5-0.9. When i-th day is at the end of the P period (i.e., i=p), then R_i tends to 0, as supposedly the purchase will actually happen at this time instance and the full purchase reward of 10 points will be awarded at that state.

For example, the following reward values can be assigned:
Reward_click=1
Reward_save-to-wish-list=5
Reward_purchase=10

Now reward-intent-to-purchase (i.e., based on a count of days) will be broken down in values to the number of days P such that at each day i, it adds:

R_i=0.5 ̂i*10.

Thus, for example, when P is 14 days, and the model is at day No. 7, R_i=(0.5̂7)*(p−i)*10=0.0078*(14−7)/14*10=0.039 points. At i=1 first day after the intent signal, R_1=0.5 ̂1*(14−1)/14*10=4.64 points.

Therefore, the above model of reward calculating accounts for a time period since the action by agent 110 (e.g., presenting a purchase recommendation) and until a particular user action (e.g., delayed purchase) is identified. Thus, the faster the user action, the higher reward, and vice versa.

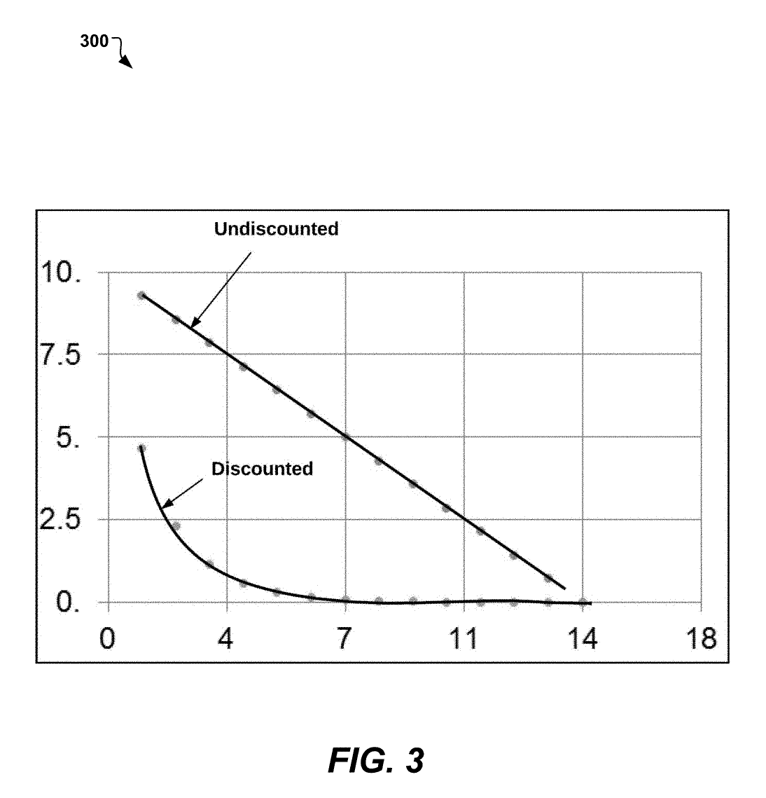

FIG. 3 shows a graph 300 depicting calculated reward values where a lower curve characterizes a discounted calculation model, while an upper curve characterizes an undiscounted calculation model. In other words, the discounted calculation model is used to calculate reward values in a time-decaying manner. As shown in the figure, the undiscounted calculation model represents a simple linear time-decaying function.

Table 1 below shows a 14-day cumulative reward values calculated with discounting and without discounting (assuming the full reward value equals 10). In certain embodiments, Table 1 or a similar table can be utilized by deep reinforcement learning system 105 as a look-up table to identify a reward based on a number of days lapsed since a predetermined user action. In this case, Table 1 can reduce computational resources to determine an appropriate reward in a given state of deep reinforcement learning system 105.

TABLE 1

| No. of Day | Undiscounted | Discounted |
|---|---|---|
| 1 | 9.286 | 4.643 |
| 2 | 8.571 | 2.321 |
| 3 | 7.857 | 1.161 |
| 4 | 7.143 | 0.580 |
| 5 | 6.429 | 0.290 |
| 6 | 5.714 | 0.145 |
| 7 | 5.000 | 0.073 |
| 8 | 4.286 | 0.036 |
| 9 | 3.571 | 0.018 |
| 10 | 2.857 | 0.009 |
| 11 | 2.143 | 0.005 |
| 12 | 1.429 | 0.002 |
| 13 | 0.714 | 0.001 |
| 14 | 0.000 | 0.001 |

As mentioned above, deep reinforcement learning system 105 can be represented mathematically by a Markov Decision Process (MDP) which is fully represented by the equations below. Essentially, the present technology introduces a modifier to the reward of MDP, where the modifier can be an intent signal.

The optimal action-value function obeys an important identity known as the Bellman equation, which is based on the following. If the optimal value Q*(s′,a′) of the sequence s′ at the next time-step was known for all possible actions a′, then the optimal strategy is to select the action a′ maximizing the expected value of r+γQ*(s′,a′) as follows:

$${Q}^{*} ( s , a ) = {E}_{s ∼ E}^{′} [ r + γ max {Q}^{*} ( {s}^{′} , {a}^{′} ) \vert s , a ] .$$

Thus, the MDP framework has constructed the optimal action-value function to capture the sum of all future rewards. However, the intent signal is introduced, which effectively characterizes that there is a latent reward in a given state or a specific action that causes a specific state transition.

The above equation can be changed by replacing r with the following:

r=r+I(t)

where I is the time-decayed intent at that time step t associated with taking an action a from state S to S′. Notably, the intent I can be either a sub-reward or a totally different dimension reward that could impact the optimal value function.

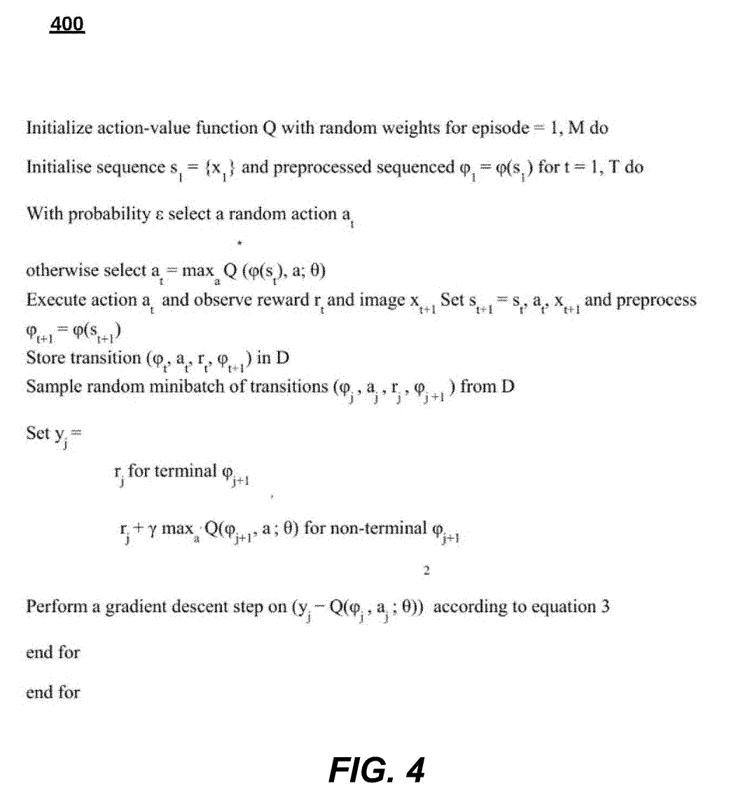

FIG. 4 shows an example pseudo code 400 which can be used to implement the MDP framework for performing at least a part of methods for delivering purchase recommendations as described herein.

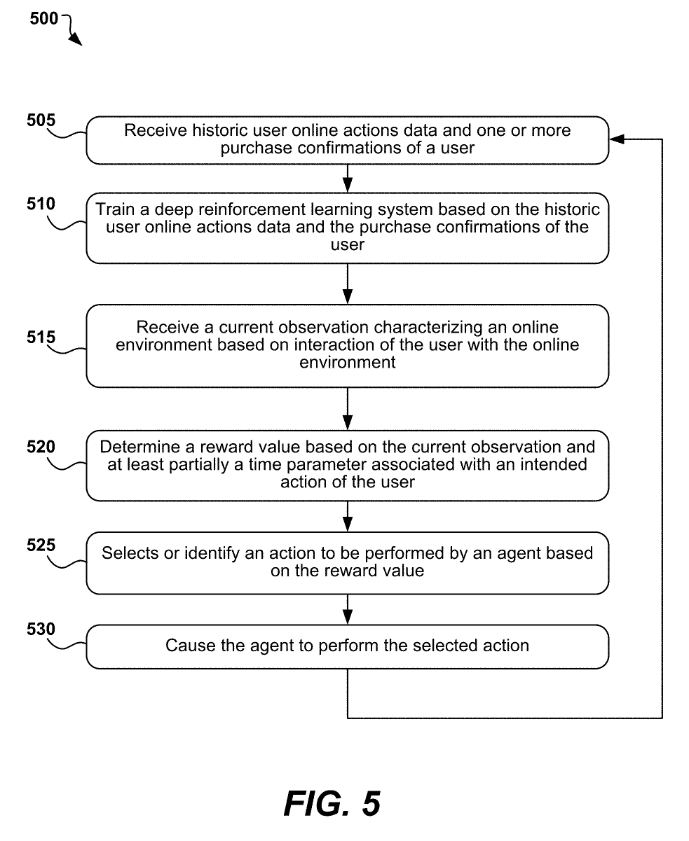

FIG. 5 is a flow diagram of an example method 500 for delivering purchase recommendations according to one embodiment. Method 500 may be performed by processing logic that may comprise hardware, software, or a combination of both. In one example embodiment, the processing logic refers to appropriately programmed system architecture 100 as described above. Below recited operations of method 500 may be implemented in an order different than described and shown in the figure. Moreover, method 500 may have additional operations not shown herein, but which can be evident for those skilled in the art from the present disclosure. Method 500 may also have fewer operations than outlined below. Furthermore, operations 505-530 of method 500 can be performed cyclically and repeatedly.

Method 500 commences at operation 505 with deep reinforcement learning system 105 receiving historic user online actions data and one or more purchase confirmations of a user. This information can be collected over time from online environment 115 or from any other suitable source such as a database or a third party resource.

At operation 510, deep reinforcement learning system 105 is trained based on the historic user online actions data and the purchase confirmations of the user to enable deep reinforcement learning system 105 to provide one or more purchase recommendations to the user. In addition, the training enables deep reinforcement learning system 105 to optimize a policy of presenting the purchase recommendations to the user and narrowly tailor the purchase recommendations to the user based on his interests and preferences. As described above, the purchase recommendations are presented to the user via online environment 115 such as a merchant website or a mobile application.

In addition, it should be noted that the information collected at operation 505 can be related to the user actions, actions of comparable users, or both. In other words, in certain embodiments, the historic data and the purchase confirmations can be of users B, C, and D in order to train deep reinforcement learning system 105 at operation 510 to act in a particular manner with respect to a particular user A. In other implementations, however, the collected information at operation 505 can relate to user A only and be used to train deep reinforcement learning system 105 at operation 510 to act in a particular manner with respect to the same user A.

At operation 515, the user interacts with online environment 115 in response to the purchase recommendations presented. The user interaction can involve one or more user actions such as reviewing the purchase recommendations, clicking on the purchase recommendations, activating the purchase recommendations, making a purchase of products or services associated with the purchase recommendations, save for later, and so forth. Accordingly, at operation 515, deep reinforcement learning system 105 receives a current observation characterizing the user action or online environment 115 based on the interaction of the user with the online environment 115 and at least one of the purchase recommendation.

In some embodiments, deep reinforcement learning system 105 can also receive one or more additional observations associated with intermediate user actions performed by the user after the purchase recommendation is presented to the user and before the user makes an online purchase of a product or service associated with the purchase recommendation (or performs another predefined action). The intermediate user actions characterize a user delayed intent to make a purchase associated with the purchase recommendations.

At operation 520, deep reinforcement learning system 105 determines, selects, searches for, or calculates a reward value based on the current observation and at least partially a time parameter associated with an intended action of the user. The time parameter can be an intent signal characterizing the user delayed intent or a time delay between a time instance when a particular purchase recommendation is presented to the user and a time instance when the user performs a predefined action (such as a click or purchase of the product associated with the purchase recommendation).

In the embodiments, where the additional observations are received, the reward for deep reinforcement learning system 105 is determined based on both the observation and the additional observation(s). Particularly, deep reinforcement learning system 105 can model a partial reward based on the additional observation(s) such that the reward calculated based on the observation also includes the partial reward calculated based on the additional observation(s).

As discussed above, the partial reward can be modeled as a time-decaying function causing to reduce an impact of the user delayed intent to make a purchase on determining (calculating) the reward. Particularly, the time-decaying function of the partial reward can cause reducing the reward with the increase of time elapsed since the purchase recommendations are provided or displayed to the user. In one embodiment, the time-decaying function includes a simple linear decay function, but not necessarily. In other embodiments, the time-decaying function includes a lookup table, which can optionally be customizable by at least one merchant.

Furthermore, the time decay function can itself be learned by a neural network that can predict the decay rate based on past patterns of correlating the intent signal and actual purchases. In an embodiment such a neural network could be a Recurrent neural network such as a Long Short Term Memory (LSTM) network

At operation 525, deep reinforcement learning system 105 selects or identifies an action to be performed by agent 110 based on the reward value. At operation 530, deep reinforcement learning system 105 causes agent 110 to perform the selected action. For example, at operation 525, deep reinforcement learning system 105 can send an instruction or command to agent 110 to perform the selected action. The selected action can include presenting or displaying a new purchase recommendation to the user or another comparable user. The new purchase recommendation can be more relevant to the user than the purchase recommendation presented earlier as a result of the training of deep reinforcement learning system 105.

In yet additional embodiments, deep reinforcement learning system 105 can receive historic multiple user session data of a plurality of comparable users (i.e., other users that are similar or similarly situated to the user). The historic multiple user session data characterize delayed intent to make a purchase of the comparable users and purchase conversion. Deep reinforcement learning system 105 can be further trained based on the historic multiple user session data to enable deep reinforcement learning system 105 to increase accuracy of modeling the partial reward.

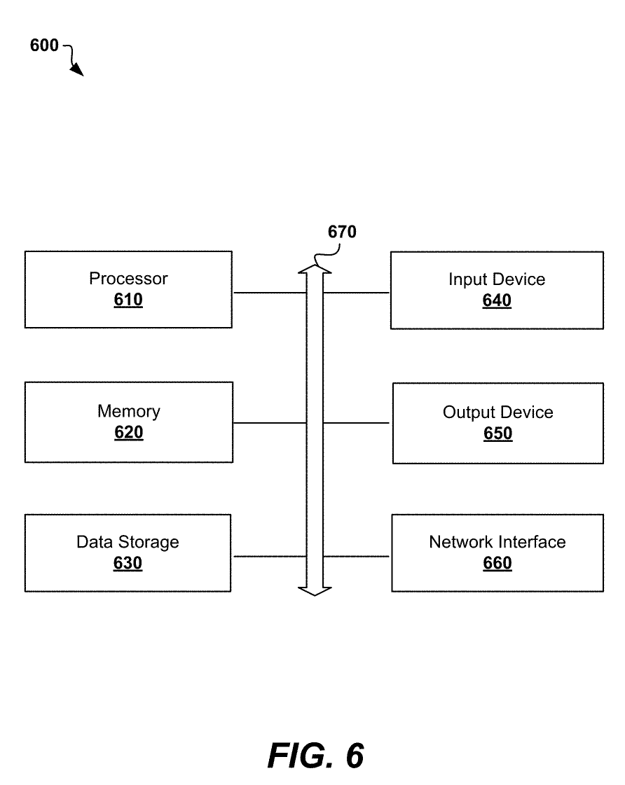

FIG. 6 illustrates an example computer system 600 which can be used to perform the methods for delivering purchase recommendations according to one embodiment as disclosed herein. Computer system 600 can be an instance of a computing device or server employing deep reinforcement learning system 105, agent 110, and/or online environment 115. With reference to FIG. 6, computing system 600 includes one or more processors 610, one or more memories 620, one or more data storages 630, one or more input devices 640, one or more output devices 650, network interface 660, one or more optional peripheral devices, and a communication bus 670 for operatively interconnecting the above-listed elements. Processors 610 can be configured to implement functionality and/or process instructions for execution within computing system 600. For example, processors 610 may process instructions stored in memory 620 or instructions stored on data storage 630. Such instructions may include components of an operating system or software applications necessary to implement the methods for delivering purchase recommendations as described above.

Memory 620 can be configured to store information within computing system 600 during operation. For example, memory 620 can store instructions to perform the methods for delivering purchase recommendations as described herein. Memory 620, in some example embodiments, may refer to a non-transitory computer-readable storage medium or a computer-readable storage device. In some examples, memory 620 is a temporary memory, meaning that a primary purpose of memory 620 may not be long-term storage. Memory 620 may also refer to a volatile memory, meaning that memory 620 does not maintain stored contents when memory 620 is not receiving power. Examples of volatile memories include RAM, dynamic random access memories (DRAM), static random access memories (SRAM), and other forms of volatile memories known in the art. In some examples, memory 620 is used to store program instructions for execution by processors 610. Memory 620, in one example, is used by software applications or mobile applications. Generally, software or mobile applications refer to software applications suitable for implementing at least some operations of the methods as described herein.

Data storage 630 can also include one or more transitory or non-transitory computer-readable storage media or computer-readable storage devices. For example, data storage 630 can store instructions for processor 610 to implement the methods described herein. In some embodiments, data storage 630 may be configured to store greater amounts of information than memory 620. Data storage 630 may be also configured for long-term storage of information. In some examples, data storage 630 includes non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Computing system 600 may also include one or more input devices 640. Input devices 640 may be configured to receive input from a user through tactile, audio, video, or biometric channels. Examples of input devices 640 may include a keyboard, keypad, mouse, trackball, touchscreen, touchpad, microphone, video camera, image sensor, fingerprint sensor, scanner, or any other device capable of detecting an input from a user or other source, and relaying the input to computing system 600 or components thereof.

Output devices 650 may be configured to provide output to a user through visual or auditory channels. Output devices 650 may include a video graphics adapter card, display, such as liquid crystal display (LCD) monitor, light emitting diode (LED) monitor, or organic LED monitor, sound card, speaker, lighting device, projector, or any other device capable of generating output that may be intelligible to a user. Output devices 650 may also include a touchscreen, presence-sensitive display, or other input/output capable displays known in the art.

Computing system 600 can also include network interface 660. Network interface 660 can be utilized to communicate with external devices via one or more communications networks such as a communications network or any other wired, wireless, or optical networks. Network interface 660 may be a network interface card, such as an Ethernet card, an optical transceiver, a radio frequency transceiver, or any other type of device that can send and receive information.

An operating system of computing system 600 may control one or more functionalities of computing system 600 or components thereof. For example, the operating system may interact with the software or mobile applications and may facilitate one or more interactions between the software/mobile applications and processors 610, memory 620, data storages 630, input devices 640, output devices 650, and network interface 660. The operating system may interact with or be otherwise coupled to software applications or components thereof. In some embodiments, software applications may be included in the operating system.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

What is claimed is:

1. A computer-implemented method for delivering behavioral recommendations including purchase recommendations, comprising:
receiving historic user online actions data and one or more purchase confirmations of a user;
training a deep reinforcement learning system based on the historic user online actions data and the purchase confirmations of the user to enable the deep reinforcement learning system to provide one or more purchase recommendations to the user;
receiving a current observation characterizing interaction of the user with at least one of the purchase recommendation of the deep reinforcement learning system presented in an online environment;
determining a reward for the deep reinforcement learning system based on the current observation, wherein the reward at least partially depends on a time parameter associated with an intended action of the user;
selecting an action to be performed by an agent of the deep reinforcement learning system based on the reward; and
causing the agent to perform the selected action, wherein the selected action includes presenting or displaying a new purchase recommendation to the user or another comparable user.

2. The method of claim 1, wherein said one or more purchase recommendations are provided to the user via a website.

3. The method of claim 1, wherein said one or more purchase recommendations are provided to the user via a mobile application.

4. The method of claim 1, further comprising:
obtaining one or more additional observations of intermediate user actions performed by the user between said one or more purchase recommendations are provided to the user and before the user makes an online purchase of a product associated with said one or more purchase recommendations, wherein said one or more additional observations characterize a user delayed intent to make a purchase associated with said one or more purchase recommendations, and
wherein the reward for the deep reinforcement learning system is further determined based on said one or more additional observations.

5. The method of claim 4, further comprising:
modeling a partial reward for the deep reinforcement learning system based on said one or more additional observations, and
wherein the action to be performed by the agent is selected based on the reward and the partial reward.

6. The method of claim 5, wherein the partial reward is modeled as a time-decaying function causing to reduce an impact of the user delayed intent on determining the reward.

7. The method of claim 6, wherein the time-decaying function of the partial reward is configured to cause reducing the reward with the increase of time elapsed since said one or more purchase recommendations are provided or displayed to the user.

8. The method of claim 7, wherein the time-decaying function includes a simple linear decay function.

9. The method of claim 7, wherein the time-decaying function includes a lookup table, wherein the lookup table being customizable by at least one merchant.

10. The method of claim 7, wherein the time-decaying function of the partial reward is learned by a neural network that is trained on past patterns of correlating the user delayed intent with actual purchases

11. The method of claim 7, wherein the time-decaying function of the partial reward is learned by a Recurrent neural network.

12. The method of claim 11, wherein the Recurrent neural network is a Long-Short-Term Memory (LSTM) network.

13. The method of claim 7, further comprising:
receiving historic multiple user session data of a plurality of comparable users, wherein the historic multiple user session data characterize delayed intent to make a purchase of the comparable users and purchase conversion; and
training the deep reinforcement learning system based on the historic multiple user session data to enable the deep reinforcement learning system to increase accuracy of modeling the partial reward.

14. The method of claim 1, wherein the historic user online actions data and said one or more purchase confirmations are associated with a plurality of comparable users.

15. A system for delivering purchase recommendations comprising a processor and a memory storing processor-executable code, wherein the processor is configured to execute the processor-executable code to:
receive historic user online actions data and one or more purchase confirmations of a user;
train a deep reinforcement learning system based on the historic user online actions data and the purchase confirmations of the user to enable the deep reinforcement learning system to provide one or more purchase recommendations to the user;
receive a current observation characterizing interaction of the user with at least one of the purchase recommendation of the deep reinforcement learning system presented in an online environment;
determine a reward for the deep reinforcement learning system based on the current observation, wherein the reward at least partially depends on a time parameter associated with an intended action of the user;
select an action to be performed by an agent of the deep reinforcement learning system based on the reward; and
cause the agent to perform the selected action, wherein the selected action includes presenting or displaying a new purchase recommendation to the user or another comparable user.

16. The system of claim 15, wherein the processor is further configured to execute the processor-executable code to:
obtain one or more additional observations of intermediate user actions performed by the user between said one or more purchase recommendations are provided to the user and before the user makes an online purchase of a product associated with said one or more purchase recommendations, wherein said intermediate user actions characterize a user delayed intent to make a purchase associated with said one or more purchase recommendations, and
wherein the reward for the deep reinforcement learning system is further determined based on said one or more additional observations.

17. The system of claim 16, wherein the processor is further configured to execute the processor-executable code to:
model a partial reward for the deep reinforcement learning system based on said one or more additional observations, and
wherein the action to be performed by the agent is selected based on the reward and the partial reward.

18. The system of claim 17, wherein the partial reward is modeled as a time-decaying function causing to reduce an impact of the user delayed intent on determining the reward.

19. The system of claim 17, wherein the time-decaying function of the partial reward is configured to cause reducing the reward with the increase of time elapsed since said one or more purchase recommendations are provided or displayed to the user.

20. The system of claim 19, wherein the time-decaying function includes a simple linear decay function.

21. The system of claim 19, wherein the time-decaying function includes a lookup table, wherein the lookup table being customizable by at least one merchant.

22. The system of claim 19, wherein the processor is further configured to execute the processor-executable code to:
receive historic multiple user session data of a plurality of comparable users, wherein the historic multiple user session data characterize delayed intent to make a purchase of the comparable users and purchase conversion; and
train the deep reinforcement learning system based on the historic multiple user session data to enable the deep reinforcement learning system to increase accuracy of modeling the partial reward.

23. A non-transitory computer-readable medium comprising instructions stored thereon, which when executed by a computer, cause the computer to implement a method for delivering purchase recommendations, the method comprising:
receiving historic user online actions data and one or more purchase confirmations of a user;
training a deep reinforcement learning system based on the historic user online actions data and the purchase confirmations of the user to enable the deep reinforcement learning system to provide one or more purchase recommendations to the user;
receiving a current observation characterizing interaction of the user with at least one of the purchase recommendation of the deep reinforcement learning system presented in an online environment;
determining a reward for the deep reinforcement learning system based on the current observation, wherein the reward at least partially depends on a time parameter associated with an intended action of the user;
selecting an action to be performed by an agent of the deep reinforcement learning system based on the reward; and
causing the agent to perform the selected action, wherein the selected action includes presenting or displaying a new purchase recommendation to the user or another comparable user.
